(19) United States
(12) Patent Application Publication
(10) Pub. No.: US 2012/0290351 A1
(43) Pub. Date: Nov. 15, 2012

(54) SYSTEM FOR AUTOMATED SALES TEAM IDENTIFICATION AND/OR CREATION

(75) Inventors: Mary E.G. Bear, Burlingame, CA (US); Amy Christine Wilson, Oakland, CA (US); Krishna Murty Mulukutla, Coppell, TX (US); Aylin Uysal, San Francisco, CA (US)

(73) Assignee: Oracle International Corporation, Redwood Shores, CA (US)

(21) Appl. No.: 13/104,813

(22) Filed: May 10, 2011

(51) Int. Cl. G06Q 10/00

(52) U.S. Cl. 705/7.14

(57) ABSTRACT

A system identifies candidate persons of an enterprise team, such as a sales team. An example method includes providing a first user option to select one or more persons based on a first set of one or more criteria, yielding an indication of one or more candidate persons in response thereto; retrieving data for each of the one or more candidate persons, wherein the data includes information comprising a first metric and a second metric; and providing a second user option to chose one or more candidate persons for an enterprise team based on the one or more indications of one or more candidate persons and the metrics. The example method further includes graphically depicting one or more indications of one or more candidate persons based on the first metric and the second metric, which may include measurements of a person's versatility and sales performance history, respectively.

### CROSS REFERENCES TO RELATED APPLICATIONS

This application is related to U.S. patent application Ser. No. 12/265,059, entitled EMPLOYEE TALENT REVIEW MANAGEMENT MODULE, filed on Nov. 5, 2008, which is hereby incorporated by reference, as if set forth in full in this specification for all purposes.

### BACKGROUND

The present application relates to software and more specifically to talent management applications, user interfaces, and methods for organizing and/or managing personnel and related objectives of an enterprise.

For the purposes of the present discussion, an enterprise may be any organization of persons, such as a business, university, government, military, and so on. The terms “organization” and “enterprise” are employed interchangeably herein. A talent management system or application may be any software application or functionality for facilitating selecting, organizing, or managing enterprise personnel or tasks performed thereby. Personnel of an organization may include any persons associated with the organization, such as employees, contractors, board members, and so on.

Talent management systems, also called personnel management systems herein, are employed in various demanding applications, including, but not limited to, hiring enterprise personnel, determining compensation, developing capabilities, utilizing capabilities, and constructing, organizing, and managing sales teams and associated tasks. Such applications often demand feature-rich software that can efficiently leverage available data to facilitate informed enterprise decision making.

Effective mechanisms for leveraging existing data are particularly important for selecting members of a team to address an enterprise objective, since team members may determine whether the objective is met. Conventionally, for example, to assemble a sales team to launch a new product, an enterprise may refer to personnel performance scores available via a Human Capital Management (HCM) application. However, selection of team members based on performance scores alone, or other limited data, can be problematic.

### SUMMARY

An example method for facilitating identifying candidate persons of an enterprise team includes providing a first user option to select one or more persons based on a first set of one or more criteria, yielding an indication of one or more candidate persons in response thereto; retrieving data for each of the one or more candidate persons, wherein the data includes information comprising a first metric and a second metric; and providing a second user option to chose one or more candidate persons for an enterprise team based on the one or more indications of one or more candidate persons and the metrics.

In an illustrative embodiment, the enterprise team includes a sales team. The method further includes graphically depicting one or more indications of one or more candidate persons based on the first metric and the second metric. The resulting graphical depiction, also called a visualization, may be a graph, such as a scatter plot. The one or more indications may be icons or other graphics associated with or otherwise symbolizing enterprise personnel or data objects associated therewith. The first metric includes a measurement of versatility of a person. The second metric includes a measurement of sales performance, which, for example, may be based on sales quota attainment history.

In a specific embodiment, a user interface control facilitates selectively overlaying data on the graphical depiction. Data may be overlaid, for example, by providing a color-coded legend and then color coding the indications or icons according to the legend and data selected to be overlaid. Examples of data that may be overlaid include industry information, names, and mobility metric(s) associated with each indication.

Additional user options facilitate assigning a task and/or goal to one or more persons associated with a displayed indication; adding a note associated with one or more persons corresponding to a displayed indication; deleting an indication of a person from the visualization, and so on.

The example data retrieving step may further include obtaining data from an Incentive Compensation (IC) system, a Customer Relationship Management (CRM) system, a Human Capital Management (HCM) system, and/or from other software in an Enterprise Resource Planning (ERP) system.

The first user option may include a population filter for filtering persons based on predetermined criteria, such as job, organization, subordinate level, location, product knowledge, proficiency scores, and so on. Data pertaining to the criteria may be retrieved from one or more of the ERP software applications, e.g., IC, CRM, or HCM systems.

The specific embodiment further includes providing a user interface control for assigning, to a group space, one or more chosen candidate persons for a sales team. The group space may include communication and collaboration functionality.

The novel design of certain embodiments discussed herein is facilitated by the data retrieving step, which may involve leveraging plural data sources available within an enterprise to facilitate making informed personnel choices when choosing an enterprise team. Conventionally, enterprise applications, such as CRM, HCM, IC, Project Management (PM), Business Intelligence (BI), and so on, may capture different types of data. Examples of such data include customer acquisition, lead generation, sales quota attainment, individual talent scores and performance ratings career aspiration and succession plans, strengths, leadership potential and advancement readiness, enterprise objectives or goals, and so on. However, effective mechanisms for leveraging data from the various applications is lacking. Hence, conventionally, businesses lack insightful tools for enabling a more holistic view of their workforce in view of their business objectives or targets.

In certain embodiments discussed herein, the data retrieved from various enterprise applications may be overlaid on visualizations; may be incorporated into displayed metrics; may be used in population filters to select initial candidate sales team members, and so on. The data, which may include measurements of individual motivations, aspirations and strengths, and so on, can be particularly insightful for businesses making important talent management decisions.

The additional user option to assign selected enterprise team members to particular collaborative spaces may further facilitate accomplishment of enterprise objectives, e.g., by facilitating team communication. Hence, certain embodiments discussed herein may facilitate not only selecting preferred persons to address a particular objective or initiative, but may facilitate team collaboration to address preferred business objectives. This may facilitate efficient accomplishment of enterprise objectives.

Hence, certain embodiments discussed herein may provide tools for selectively employing data from multiple systems to facilitate creation of effective and results-based sales teams and providing the resulting teams with effective collaboration tools for addressing selected business objectives, such as sales project initiatives.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram illustrating an example embodiment of an enterprise system including a personnel selection and management module.

FIG. 2 is a diagram illustrating a first example user interface display screen, which may be generated via the system of FIG. 1.

FIG. 3 is a more detailed diagram of an information section of the user interface display screen of FIG. 2.

FIG. 4 is a more detailed diagram of an actions section of the user interface display screen of FIG. 2.

FIG. 5 is a diagram of an example dialog box, which may be accessible via the actions section depicted in FIG. 4, for assigning filtered enterprise personnel to a group space or sales team.

FIG. 6 is diagram illustrating a second example user interface display screen after plural information layers have been applied to the user interface display screen of FIG. 2.

FIG. 7 is a flow diagram of a first example method adapted for use with the embodiments of FIGS. 1-6.

FIG. 8 is a flow diagram of a second example method adapted for use with the embodiments of FIGS. 1-6.

### DETAILED DESCRIPTION OF EMBODIMENTS

Although the description has been described with respect to particular embodiments thereof, these particular embodiments are merely illustrative, and not restrictive.

While the present application is discussed with respect to selection, creation, and management of sales teams or groups to address an enterprise objective or initiative, embodiments are not limited thereto. For example, any organization may benefit from use of embodiments and tools discussed herein to better understand employee characteristics and talents to enhance decision making, regardless of whether such tools are employed to select a particular sales team.

Furthermore, while certain embodiments discussed herein may leverage data available via preexisting Enterprise Resource Planning (ERP) software applications, embodiments are not limited thereto. For example, certain embodiments may be adapted to pull data from sources other than ERP applications, such as remote data stores. In certain implementations, industry-wide data, such as may be obtained from the Internet, may be collected and displayed in combination with data pertaining to particular enterprise personnel.

For the purposes of the present discussion, ERP software may be any set of computer code that is adapted to facilitate managing resources of an organization. Example resources include Human Resources (HR), financial resources, assets, employees, and so on, of an enterprise. The terms “ERP software” and “ERP application” may be employed interchangeably herein. However, an ERP application may include one or more ERP software modules or components, such as user interface software modules or components.

An Incentive Compensation (IC) system, also called a compensation management system, may be any collection of software components, such as a database, adapted to facilitate managing and allotting compensation and incentives to persons associated with an enterprise. Examples of compensation include salaries, commissions, retirement benefits, healthcare programs, vacation allotment, and so on. Examples of incentives include offers to increase or decrease compensation based on individual performance.

A Customer Relationship Management (CRM) system may be any software that is adapted to facilitate managing, organizing, or controlling business process, such as sales activities, involving customers. Certain CRM systems may track sales performance, such as quota attainment consistency, frequency, and/or track record of enterprise employees.

A Human Capital Management (HCM) system, also called a human resource management system, may be any software that is adapted to facilitate managing persons of an enterprise. Certain HCM systems are adapted to facilitate hiring, retaining, using and developing capabilities of enterprise personnel, and so on. Note that various types of systems may include other system. For example certain HCM systems may include IC systems and talent management systems as components thereof.

For clarity, certain well-known components, such as hard drives, processors, operating systems, power supplies, and so on, have been omitted from the figures. However, those skilled in the art with access to the present teachings will know which components to implement and how to implement them to meet the needs of a given application.

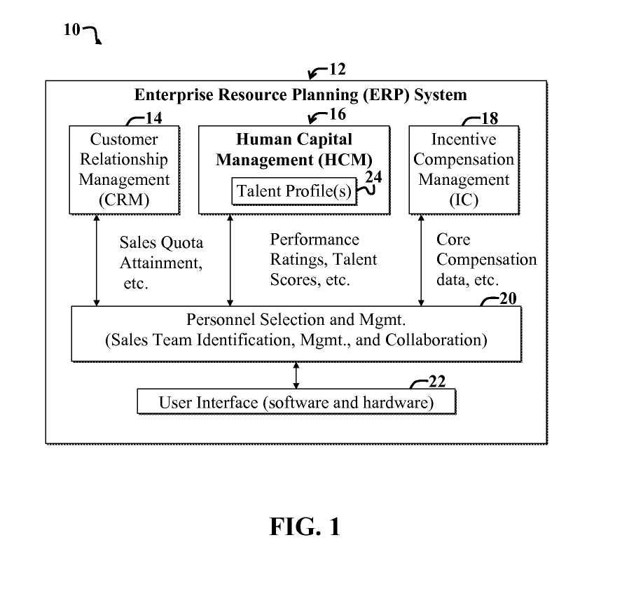

FIG. 1 is a diagram illustrating an example embodiment of an ERP system 10, including a personnel selection and management system 20, which represents a sub-system of the ERP system 12. Other example subsystems of the ERP system 12 include a CRM system 14, an HCM system 16, and an IC system 18, which all communicate with the personnel selection and management system 20.

A user interface 22 communicates with the personnel selection and management system 20. The user interface 22 may include software components for generating display screens, and hardware components, such as monitors, keyboards, and so on, for interacting with the user interface software. Note that while various components 14-22 of the ERP system 12 are represented by separate modules, various modules may be integrated or combined into one or more modules without departing from the scope of the present teachings. Furthermore, the ERP system 12 may be implemented on a single computer system or may be distributed among computing resources of a network.

In operation, the personnel selection and management system 20 includes software routines, i.e., computer code, for selectively retrieving data from various ERP system components, such as the CRM system 14, HCM system 16, and IC system 18. The retrieved data may include, for example, individual talent scores, performance ratings, sales quota attainment data, compensation data, career aspirations, and so on. Routines running on the personnel selection and management system 20 are adapted to selectively present the data to users, such as certain corporate executives or HR administrators, who have access the user interface 22. The data is selectively presented, in response to manipulation of the user interface 22, via user interface display screens and accompanying visualizations and user interface controls provided by the user interface 22, as discussed more fully below. The user interface 22 and personnel selection and management system 20 are adapted to facilitate strategically identifying and selecting enterprise personnel for inclusion in an enterprise team in view of one or more objectives or initiatives to be addressed by the team. For example, an enterprise that wishes to assemble a sales team to address a sales initiative pertaining to a new product launch may employ the personnel selection and management system 20 to filter candidate team members based on chosen criteria or parameters; to further view aggregated data for each candidate person, such as via visualizations or plots and data overlays on the visualizations; to further select persons for a team or group; and to and assign the selected persons to collaborative group spaces.

For the purposes of the present discussion, a group space may be any user interface display screen or mechanism whereby plural users may simultaneously access the user interface display screen or mechanism. In general, in embodiments discussed herein, enterprise teams, also called personnel teams, are assigned a common group space to facilitate collaboration.

For the purposes of the present discussion, an enterprise team may be any group of one or more persons that are chosen to or otherwise participate in a common effort, such as an enterprise initiative or objective. An enterprise initiative or objective may be a grouping or sequence of one or more goals or tasks to be addressed.

Information visualization may be any process involving graphically representing data according to a method or scheme. A graphical representation of data resulting from an information visualization technique is often called a visualization. Example visualizations include pie charts, treemaps, bar charts, graphs, personnel scatter plots, and so on.

For the purposes of the present discussion, a personnel plot, such as a personnel scatter plot, may be any graph or visualization showing representations of or indication of persons at various positions of a displayed area based on one or more metrics. Examples of representations or indications include icons, text, or other graphically displayable features.

A metric may be any measurement, parameter, or other indicator associated with a person or thing. Examples of metrics include sales performance scores, versatility levels, and so on. For the purposes of the present discussion, versatility of a person may be any measurement quantifying the persons ability to adapt to various work environments or to accomplish a new set of enterprise objectives or tasks.

In the present example embodiment, versatility measurements of enterprise personnel may be retrieved from preexisting software, such as talent profile(s) 24 included in the HCM module 16. Alternatively, one or more algorithms running on the personnel selection and management system 20 may strategically combine data from one or more of the ERP components 14-18 to generate a metric indicative of a person's versatility. Such an algorithm may be predefined and fixed in the personnel selection and management system 20. Alternatively, mechanisms for enabling users of the ERP system 10 to determine how versatility is calculated may be included in the personnel selection and management system 20. Exact details of how versatility metrics are calculated are implementation specific. Those skilled in the art with access to the present teachings may readily determine and implement appropriate algorithms or metrics for calculating versatility to meet the needs of a given implementation without undue experimentation.

For example, certain businesses may wish to base versatility measurements on data indicating whether a person has demonstrated an ability to accomplish sales goals in the fields of oil and gas, high technology, and computer packaged goods in combination with a measurement of the person's promotion potential. Other user businesses may wish to base versatility measurements upon responses provided in questionnaires or based on other mechanisms.

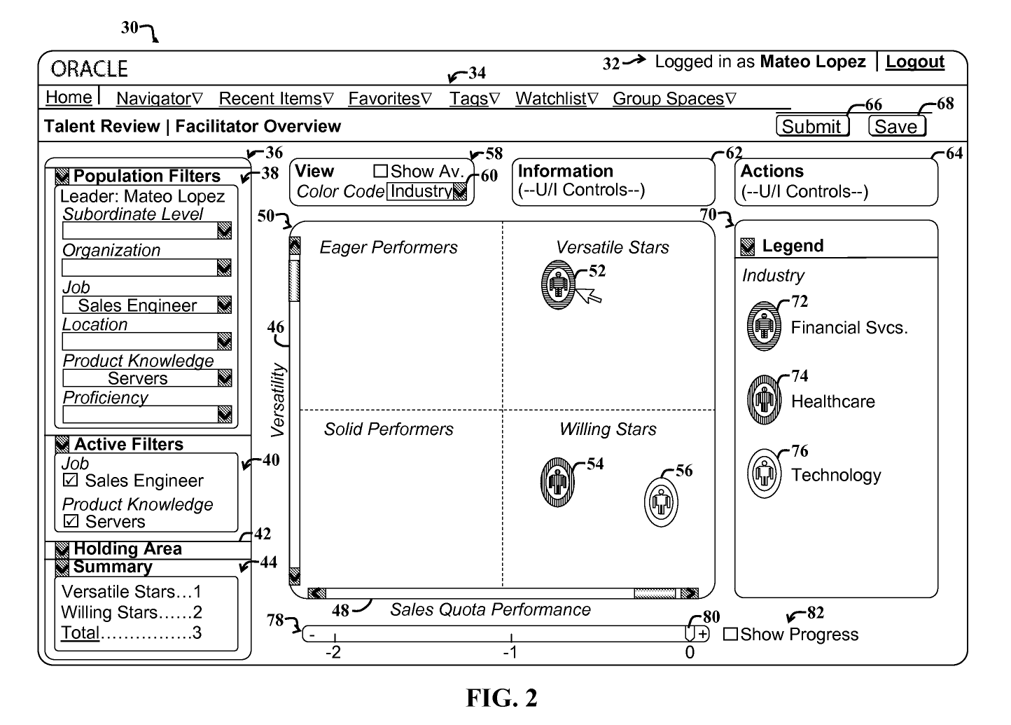

FIG. 2 is a diagram illustrating a first example user interface display screen 30, which may be generated via the system 10 and displayed via accompanying user interface 22 of FIG. 1. The example user interface display screen 30 includes a log-in indication 32, indicating the authorized user (Mateo Lopez) who is currently logged in to the system 20 of FIG. 1.

The display screen 30 further includes a menu bar 34 with menus for accessing various functionality. A filter section 36 is positioned below the menu bar 34 on the left side of the display screen 30. The filter section 36 includes a population filter section 38, an active filter section 40, a holding area 42, and a summary section 44.

The population filter section 38 includes various user interface controls, e.g., drop-down menus, for filtering a set of enterprise personnel (based on one or more predetermined criteria) to yield an initial candidate set of filtered enterprise personnel. For the purposes of the present discussion, filtered enterprise personnel may be any persons or representations, depictions, or indications thereof, remaining after a population filter is applied to a set of enterprise personnel. A population filter may be any mechanism for omitting one or more persons or indications thereof from a population of persons based on one or more criteria, yielding a remaining population. Persons of the remaining population may be considered candidate persons, i.e., persons selected for a candidate group of persons. Examples of criteria used for population filters in the present example embodiment include subordinate level, organization, job, location, product knowledge, and proficiency.

For the purposes of the present discussion, a subordinate level of a person may be a rank or position in an enterprise hierarchy or may refer to the name of the rank or position. A hierarchy may be any arrangement of persons or representations or indications thereof, where the persons, representations, or indications may exhibit superior or subordinate relationships with other persons. A hierarchy may refer to a displayed representation of data items or may refer to data and accompanying relationships existing irrespective of the representation. For example, an enterprise hierarchy may be any power structure or position structure defining powers or privileges of personnel for an organization.

In the present example embodiment, population filter criteria are selected from drop down menus provided in the population filter section 38. Note that while drop down menus are shown, other types of user interface controls, such as check boxes, search fields, and so on, may be employed to select filtering criteria without departing from the scope of the present teachings. Examples of other population filtering mechanisms, which may be employed in embodiments within the scope of the present teachings, are discussed on co-pending U.S. patent application Ser. No. 12/265,059, filed Nov. 5, 2008, entitled EMPLOYEE TALENT REVIEW MANAGEMENT MODULE, the teachings of which are incorporated herein by reference.

Application of the population filters 38 results in selection of enterprise personnel, i.e., filtered enterprise personnel, from an available set of enterprise personnel. The available set of enterprise personnel may be all personnel for which data exists on the ERP system 10 of FIG. 1. Alternatively, the initial set of available enterprise personnel may be pre-filtered, e.g., to include only enterprise personnel that are available to be assigned to a given enterprise team to address a particular enterprise objective or initiative. User options for selecting criteria for pre-filtering may be provided, for example, in the population filter section 38.

In the present example embodiment, two population filters have been applied; in particular, a job filter and a product knowledge filter. The job filter criteria is set to Sales Engineer, while the product knowledge criteria is set to Servers. Indicators specifying which population filters and associated criteria have been applied, i.e., are active, are provided in the active filter section 40.

An optional holding area section 42 may include a listing of personnel that have been deleted or otherwise omitted from a graph 50, as discussed more fully below. The holding area section 42 may be used for other purposes without departing from the scope of the present teachings.

The filtered enterprise personnel may each be associated with various types of data, e.g., performance scores, compensation levels, sales quota performance, and so on, retrieved from the components 14-18 of the ERP system 10 of FIG. 1. Some or all of the data may form the basis for a versatility metric and a sales quota performance metric associated with each filtered enterprise personnel.

Metrics of enterprise personnel are considered characteristics of the enterprise personnel for the purposes of the present discussion. The metrics are used to categorize filtered enterprise personnel into categories, such as versatile stars, willing stars, eager performers, and solid performers, as discussed more fully below.

The summary section 44 of the filter section 36 illustrates the numbers of filtered enterprise personnel in each category. In the present example embodiment, three persons remain after filtering an initial population of enterprise personnel. The remaining filtered enterprise personnel include one versatile star and two willing stars.

Indications, i.e., representations, of filtered enterprise personnel are plotted on the graph 50 based on versatility and sales quota performance metrics. The graph 50, also called a personnel plot, includes a vertical axis corresponding to the versatility metric, and includes a horizontal axis 48 corresponding to the sales quota performance metric. The exact choices of metrics used to categorize filtered enterprise personnel and to plot representations thereof are implementation specific. User options for changing the metrics may be provided via the user interface display screen 30, without departing from the scope of the present teachings.

The example graph 50 includes four quadrants for categorizing filtered enterprise personnel according to associated versatility and sales quota performance metrics. Each quadrant represents a category of enterprise personnel. An upper left quadrant is called an eager performers quadrant. An upper right quadrant is called the versatile stars quadrant. A lower left quadrant is called the solid performers quadrant. A lower right quadrant is called a willing stars quadrant. For illustrative purposes, graphically depicted indications, i.e., icons, corresponding to filtered enterprise personnel are shown including one versatile star 52 and two willing stars 54, 56.

The user interface display screen 30 further includes a view section 58, an information section 62, and an actions section 64, which include various user interface controls, as discussed more fully below, for adjusting displayed information, overlaying information on the graph 50, and performing actions affecting or otherwise pertaining to enterprise personnel.

The view section 58 is adapted to operate in combination with a legend 70 to affect information display. For example, in the present example operative scenario, a user has selected Industry from a color code drop down menu control 60. The various icons 52-56 representing filtered enterprise personnel 52-56 are then colored or patterned according to the industry associated with each filtered enterprise personnel. The coloring or patterning associated with each industry is depicted in the legend 70. For example, the legend 70 shows a financial services color or pattern scheme 72, a healthcare color or pattern scheme 74, and a technology color or pattern scheme 76.

Note that mechanisms other than coloring or patterning may be employed to depict information on the graph 50. For example, different shapes, sizes, outlines, and so on may be applied to icons associated with different industries. Furthermore, while only three industries are represented in the present example, other industries may be shown. In addition, while the industry associated with filtered enterprise personnel is indicated, indications of other data may be provided via the view menu 58 and associated legend 70, without departing from the scope of the present teachings. In general, industries that do not characterize one or more of the depicted filtered enterprise personnel 52-56 are not shown in the legend 70.

The industry information, which is shown in response to selection from the color code drop down menu 60 of the view section 58, is considered a type of overlaid information. Other types of overlaid information, i.e., data, may be shown in response to selection of one or more user interface controls of the information section 62, as discussed more fully below.

For the purposes of the present discussion, data is said to be overlaid on a graphical depiction or visualization if additional data, other than data provided by axis or dimensions of the visualization, is displayed or otherwise depicted in combination with information pertaining to the dimensions of the visualization. For example, if names of persons are displayed on a graph in association with icons representing or depicting the persons, the names of the persons are said to represent overlaid data.

In general, to view certain types of information pertaining to filtered enterprise personnel, the corresponding icon(s) is first selected, and then a user interface control is selected from the information section 62 and/or the actions section 64. Alternatively, or in addition, functionality made available via the information section 62 and the actions section 64 may be accessible via the menu bar 34 and/or drop down menus, which may be activated, e.g., by right clicking a particular icon, as discussed more fully below.

The user interface display screen 30 further includes a time slider bar 78 and accompanying slider 80. In the present example embodiment, if the time slider 80 is moved to the left, the resulting graph 50 is updated to depict the versatility, sales quota performance, and any overlaid information for a previous point in time. The previous point in time is determined based on the position of the slider 80. Hence, the personnel selection and management system 20 of FIG. 1 and accompanying user interface 22 for rendering the display screen 30 are adapted to employ not just retrieved current or real-time data, but may use historical data to provide further insight when selecting enterprise personnel for a team in view of a business objective.

To illustrate historical movement of an icon(s) corresponding to a filtered enterprise person or persons, a show slider user interface control 82 may be selected. For example, to view a path of the versatile star 52 over time, a user may first select the versatile star 52, and then drag the slider 80 to a previous point in time, i.e., drag the slider 80 to the left. The resulting plot will illustrate the path of the versatile star 52 over an interval corresponding to the difference between the initial position of the slider 80 and the resulting position of the slider 80. Selecting the show progress user interface control 82 and dragging the slider 80 without selecting any of the icons 52-56 may simultaneously illustrate all paths of the icons 52-56 in the interval determined by movement of the slider 80.

Exact implementation and behavior details of the time slider bar 78 and accompanying slider 80 and the show progress user interface control 82 are implementation specific and may vary without departing from the scope of the present teachings. For example, in certain implementations, dragging the slider 80 after selecting the show progress user interface control 82, without having selected any of the icons 52-56, might not illustrate the progress of any of the icons 52-56 over time.

In the present example operative scenario, one or more of the icons representing filtered enterprise personnel may be selected and then added to a group space, e.g., via one or more user interface controls provided via a group spaces menu item of the menu bar 34; by an action option or control provided in the actions section 64; by an option provided via a right-click menu, and so on.

The current work area corresponding to the user interface display screen 30 may be saved, e.g., in response to selection of a save button 68 in the menu bar 34. In addition, the work area may be submitted to a predetermined entity or database and/or automatically sent to one or more predetermined recipients in response to selection of the submit button 66.

Note that the layout of various user interface components, e.g., user interface controls, and associated access to functionality of the user interface display screen 30, is implementation specific and may be varied without departing from the scope of the present teachings. For example, the time slider bar 78 may be positioned above the graph 50. Furthermore, the view section 58, information section 62, and actions section 64 may be included in tabs.

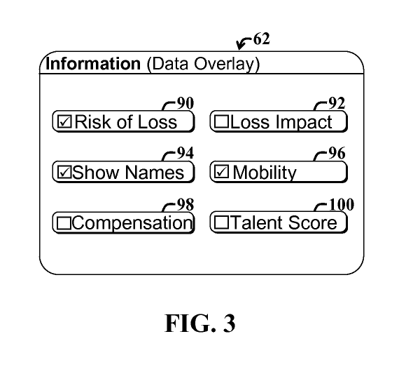

FIG. 3 is a more detailed diagram of the example information section 62 of the user interface display screen 30 of FIG. 2. With reference to FIGS. 2 and 3, the example information section 62 includes various user interface controls 90-100, which provide user options for selecting and displaying overlaid information on the personnel plot, i.e., graph 50 of FIG. 2.

In the present embodiment, the various user interface controls 90-100 are shown as check boxes. However, the controls 90-100 may be implemented via other mechanisms, such as toggle buttons, without departing from the scope of the present teachings.

The example user interface controls 90-100 include a risk of loss control 90, a loss impact control 92, a show names control 94, a mobility control 96, a compensation control 98, and a talent score control 100. Note that fewer or additional user interface controls may be provided in the information section 62 without departing from the scope of the present discussion. Furthermore, functionality provided via the various user interface controls 90-100 may be provided via other mechanisms or controls instead of or in addition to the controls 90-100 provided in the information section 62.

In operation, a user may select one or more depictions of filtered enterprise personnel, i.e., icons, from the graph 50 of FIG. 2, and then select one or more of the check boxes 90-100 to trigger the overlaying of particular data on the graph 50 in association with the selected icons. Alternatively, if none of the icons 52-56 are selected before selecting an option from the information section 62, then the selected option(s) may be applied globally to the displayed icons 52-56.

Selection of the risk of loss control 90 may cause display, via the graph 50, of metrics indicative of a person's risk of loss to the business. Exact mechanisms for displaying such metrics are implementation specific and may be varied without departing from the scope of the present teachings. For example, values corresponding to risk of loss metrics may be displayed in proximity to icons associated with personnel that are characterized by a given risk of loss metric, as discussed more fully below. Alternatively, such metrics may be displayed via a graphical feature and accompanying legend that associates the graphical feature with a value for a risk of loss metric.

Similarly, selection of the loss impact control 92, mobility control 96, compensation control 98, and talent score control 100, may cause corresponding display of information, in association with particular icons, for illustrating values of metrics for loss impact, mobility, compensation, and talent for one or more selected enterprise personnel represented by selected icons.

In the present operative scenario, the show names check box 94, risk of loss check box 90, and mobility check box 96 are selected. This may cause the names of enterprise personnel, measurements of loss risk, and measurements of mobility to appear in proximity to displayed icons associated with the enterprise personnel, as discussed more fully below.

Data for determining metrics for data overlays in response to selection of one or more of the user interface controls 90-100 may be retrieved by the personnel selection and management system 20 of FIG. 1 from various ERP components, such as the CRM system 14, HCM system 16, and/or IC system 18.

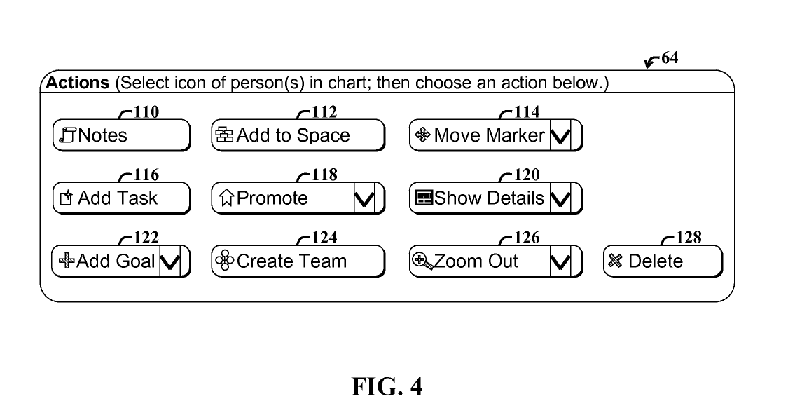

FIG. 4 is a more detailed diagram of the example actions section 64 of the user interface display screen 30 of FIG. 2. The actions section 64 includes various example user interface controls 110-128 for triggering actions in association with selected icons of the graph 50 of FIG. 2. The user interface controls 110-128 include a notes button 110, an add-to-space button 112, a move marker drop down menu 114, an add task button 116, a promote drop down menu 118, a show details drop down menu 120, an add goal drop down menu 122, a create team button, a zoom out drop down menu 126, and a delete button 128.

In operation, with reference to FIGS. 2 and 4, a user may select one or more of the icons 52-56, such as via a computer mouse. After selecting one or more of the icons 52-56, a user may then select one or more of the user interface controls 110-128, which represent user options for performing particular actions.

For example, if a user selects the icon 52 corresponding to versatile star employee and then selects the note button 110, a field for entering a note may be displayed. The resulting note may be stored in association with the enterprise employee that is associated with the selected icon. Notes may be later accessed, such as via a right-click drop down menu or other user interface mechanism. Notes associated with a particular icon may be displayed in combination with other details characterizing the person represented by the particular icon.

Similarly, selection of the add-to-space button 112 after selection of one or more of the icons 52-56 of FIG. 2 may result in adding the data object associated with the selected icon and person to a particular group space. In the present example embodiment, persons associated with or assigned to a particular group space may represent persons or candidates that have been selected for particular sales team. Once a person has been assigned to a group space, the person may automatically be granted permissions to access the group space. The group space may include one or more user interface display screens (not shown) for facilitating collective collaboration among members of the group space.

Exact construction and operation details of a particular group space are implementation specific and may readily be determined and implemented by those skilled in the art with access to the present teachings without undue experimentation. The collaborative group space may include user interface controls for sharing documents, conducting meetings, participating in forums, viewing and creating activity streams and annotations, and so on. Such collaborative tools may be implemented via well-known software mechanisms and components.

Upon selection of the add-to-space button 112, another user interface display screen or dialog box may appear with user interface controls for enabling a user to select a particular group space for which to add the selected enterprise personnel (which are selected via selection of their corresponding icons); to create a new group space; to take notes, and so on.

The move marker drop down menu 114 may provide one or more user options for controlling the position of a marker in the graph 50 of FIG. 2.

The add task button 116 provides a user option to assign a task to a selected person(s), which are selected via selection of the person's corresponding icon 52-56 of the graph 50 of FIG. 2. Selection of the add task button 116 may trigger display of another user interface display screen or dialog box, whereby a user may define or describe a task to be performed by the selected person. A selected person that has been assigned to a particular group space may then log into the group space to view tasks that have been assigned.

A user, such as an administrator, may view tasks that have been assigned to a particular person, such as by displaying a corresponding details page associated with the person. A person's details page may be accessed via one or more user interface controls, such as via a right-click drop down menu accessible via the user interface display screen 30 of FIG. 2, as discussed more fully below. The details page or other personnel details may also be accessed via the show details drop down menu 120.

The promote drop down menu 118 may provide a user option to promote a selected person to one or more predetermined positions. A promoted person that has been assigned to a particular group space may log into the group space to view promotion details. The promote button 118 and/or other options for performing actions may be provided in a personnel details page.

The add goal drop down menu 122 may provide a user option to select one or more predetermined goals from the drop down menu 122 for assignment to one or more selected persons. Methods for viewing and accessing information pertaining to goals may be similar to methods for viewing and accessing information pertaining to assigned tasks.

Selection of the create team button 124 may trigger automatic creation of or augmentation of a particular type of group space with selected persons, i.e., selected representations thereof (which may correspond to personnel data objects). The particular type of group space that is automatically generated may be called a team space. A team space, such as for a sales team, may include particular features tailored to business objectives to be addressed by the team. For example, a sales team group space may include mechanisms for accessing industry-wide sales data, customer data, and so on, pertaining to the particular product or service being sold.

The zoom out drop down menu 126 may include one or more user options for zooming out and/or zooming in on the graph 50 of FIG. 2.

The delete button 128 represents a user option to selectively delete one or more selected persons from the graph 50 of the user interface display screen 30 of FIG. 2. When an icon associated with a person is deleted, the underlying person is said to be deleted from the work area represented by the user interface display screen 30 of FIG. 2. Indications of deleted persons may be stored in the holding area 42 of FIG. 2.

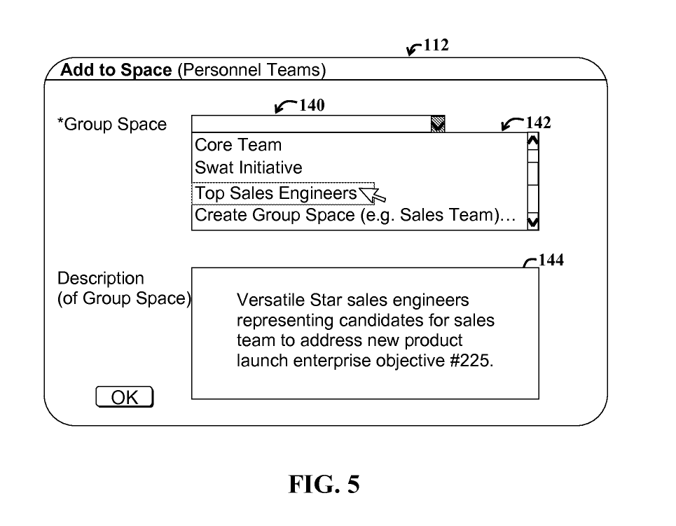

FIG. 5 is a diagram of an example dialog box 112, which may be accessible via the actions section 64 of FIG. 4, for assigning filtered enterprise personnel to a group space or sales team. With reference to FIGS. 2, 4, and 5, the add-to-space dialog box 112 may appear in response to user selection of the add-to-space button 112 of FIG. 4 after selection of one or more of the icons 52-56 of the graph 50 of FIG. 2.

In the present example embodiment, the add-to-space dialog box 112 provides a group space drop down menu 140, which provides user options 142 to select a particular group space for which to assign a particular selected person(s) corresponding to one or more selected icons 52-56 of FIG. 2. Example groups include a core team, a swat initiative team, and a top sales engineers group. The group space user options 142 further includes a user option to create a group space, such as a group space for a sales team.

For the purposes of the present discussion, an enterprise team is said to be constructed, chosen, or created when one or more selected enterprise personnel are assigned to a group space. An existing team may be modified, such as by adding or removing members from a particular group space.

Upon selection of a particular group space, or upon mouse-over of a group space in the drop down menu 140, a corresponding description appears in a description field 144. The description provided in the description field 144 may be predetermined. Alternatively, the field 144 may be edited or otherwise augmented or modified by a user after selection of a particular group space from the drop down menu 140.

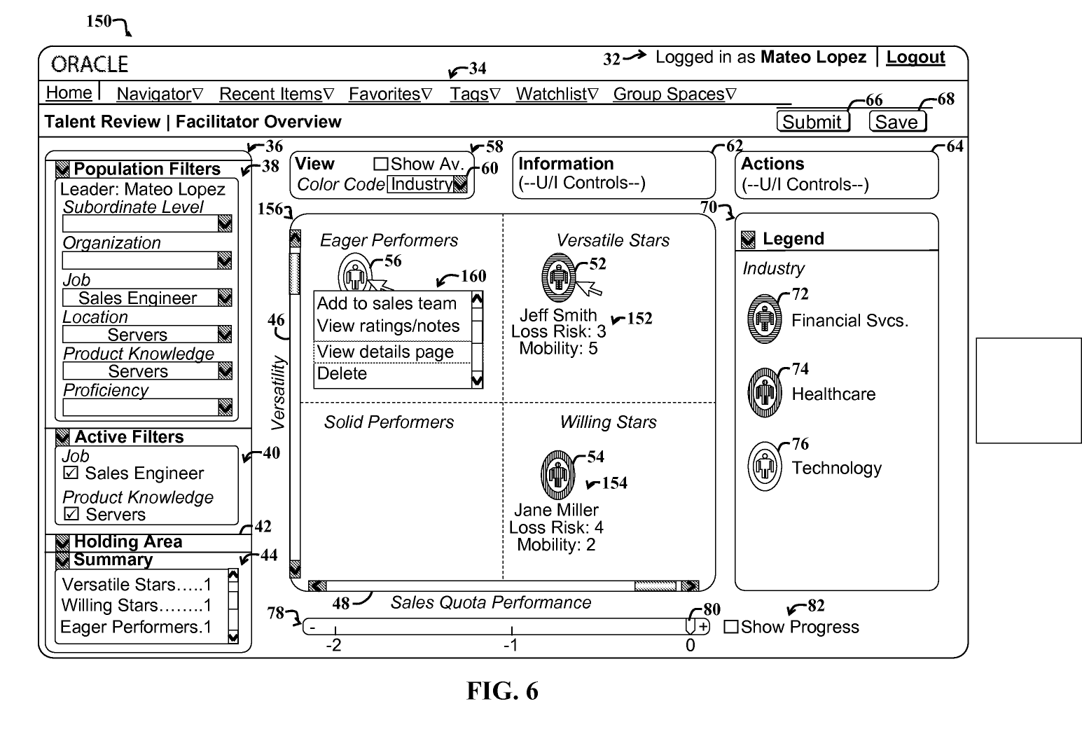

FIG. 6 is diagram illustrating a second example user interface display screen 150 after plural information layers have been applied to the user interface display screen 30 of FIG. 2. The user interface display screen 150 is similar to the user interface display screen 30 of FIG. 2 with a few exceptions. In particular, an icon right-click drop down menu 160 is displayed in association with an eager performer 56, whose versatility and sales performance metrics have been adjusted by an administrator to cause the icon 56 to transition from a willing star to an eager performer. The ability to adjust metrics associated with a given person who is associated with a given icon may be provided in a details page. The details page for a particular icon may be accessed, for example, via a user option provided in the right-click drop down menu 160.

The example right-click drop down menu 160 is shown including additional user options, such as a user option to add the associated person to a sales team or group space, a user option to view ratings and/or notes associated with the icon, and a user option to remove or delete the icon from the graph 50.

In addition, with reference to FIGS. 3 and 6, an updated graph 156 illustrates various overlaid data 152, 154 that has been overlaid in response to selection of the show names check box 94, the risk of loss check box 90, and the mobility check box 96 of the information section 62. The overlaid data 152, 154 is shown in text below the versatile star icon 52 and the willing star icon 54.

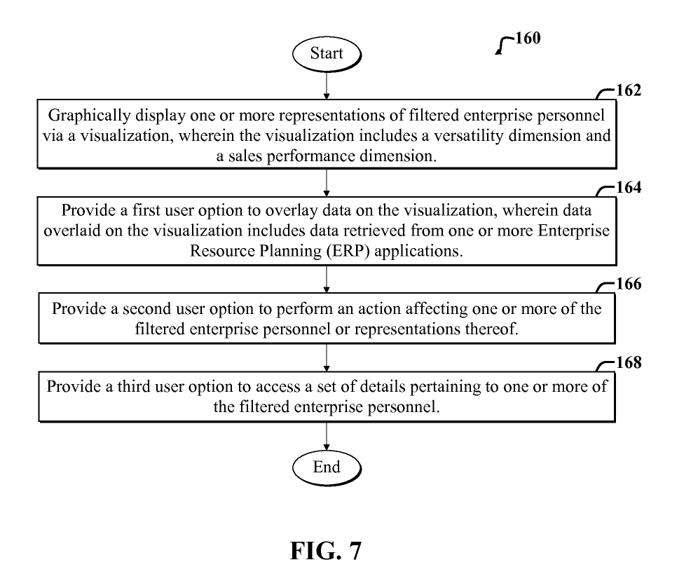

FIG. 7 is a flow diagram of a first example method 160 adapted for use with the embodiments of FIGS. 1-6. The method 160 includes a first step 162, which involves graphically displaying one or more representations of filtered enterprise personnel via a visualization. The visualization includes a versatility dimension and a sales performance dimension.

A second step 164 includes providing a first user option to overlay data on the visualization. Data overlaid on the visualization includes data retrieved from one or more Enterprise Resource Planning (ERP) applications, such as the CRM system 14, HCM system 16, and IC system 18 of FIG. 1.

A third step 166 includes providing a second user option to perform an action affecting one or more of the filtered enterprise personnel or representations thereof. Example user options for performing particular actions are show in the actions section 64 of FIG. 4.

A fourth step 168 includes providing a third user option to access a set of details pertaining to one or more of the filtered enterprise personnel.

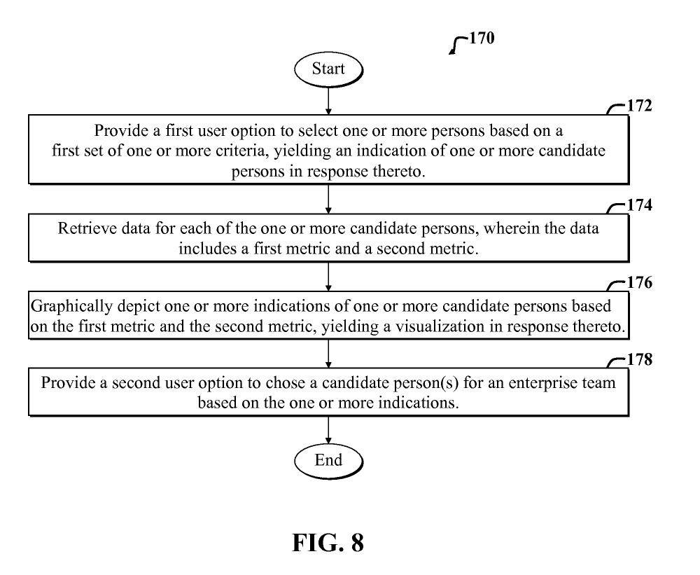

FIG. 8 is a flow diagram of a second example method 170 adapted for use with the embodiments of FIGS. 1-6. The second example method 170 includes an initial selecting step 172, which includes providing a first user option to select one or more persons based on a first set of one or more criteria, yielding an indication of one or more candidate persons in response thereto.

The initial selecting step 172 may correspond to the user options for applying population filters to an initial set of enterprise personnel. The resulting indication of one or more candidate persons may correspond to the resulting filtered enterprise personnel, as indicated in the summary section 44 and as indicated via the icons 52-56 of the graph 50 of FIG. 2.

Subsequently, a retrieving step 174 includes retrieving data for each of the one or more candidate persons, i.e., filtered enterprise personnel. The retrieved data either includes a first metric and a second metric or includes data that may be used by the personnel selection and management system 20 to calculate the first metric and/or the second metric. The first metric may represent, for example, a versatility measurement. The second metric may represent, for example, a performance metric. An example performance metric provides a measurement or indication as to whether a person has been consistently meeting sales quotas or not.

Next, a depicting step 176 includes graphically depicting one or more indications, e.g., icons of one or more candidate persons based on the first metric and the second metric, yielding a visualization in response thereto. While in certain embodiments discussed the visualization is a graph or scatter plot, note that use of other types of visualizations, such as charts, are possible.

Subsequently, a team choosing step 178 includes providing a second user option to chose a candidate person(s) for an enterprise team based on the one or more indications. A person who, for example, is represented by an icon on the graph 50 of FIG. 2, may be chosen for a particular team via use of the dialog box 112 of FIG. 5 and/or via a right-click drop down menu, such as the right-click drop down menu 160 of FIG. 6.

Note that other mechanisms for accessing the dialog box 112 of FIG. 5 may be implemented instead or in addition to those discussed, without departing from the scope of the present teachings. Furthermore, methods 160, 170 of FIGS. 7 and 8 may be modified, such as by adding, removing, and/or reordering steps to meet the needs of a given implementation.

Any suitable programming language can be used to implement features of the present invention including, e.g., C, C++, Java, PL/I, assembly language, etc. Different programming techniques can be employed such as procedural or object oriented. The routines can execute on a single processing device or multiple processors. The order of operations described herein can be changed. Multiple steps can be performed at the same time. The flowchart sequence can be interrupted. The routines can operate in an operating system environment or as stand-alone routines occupying all, or a substantial part, of the system processing. In general, any suitable programming or processing approach, design, architecture, etc. can be employed whether known now or discovered in the future.

Steps can be performed by hardware or software, as desired. Note that steps can be added to, taken from or modified from the steps in the flowcharts presented in this specification without deviating from the scope of the invention. In general, the flowcharts are only used to indicate one possible sequence of basic operations to achieve a function.

In the description herein, numerous specific details are provided, such as examples of components and/or methods, to provide a thorough understanding of embodiments of the present invention. An embodiment of the invention can be practiced without one or more of the specific details, or with other apparatus, systems, assemblies, methods, components, materials, parts, and/or the like. In some descriptions, well-known structures, materials, or operations may not be shown or described in detail.

Various software components such as processes, databases, application or operating system software, libraries, tools, etc. may reside in, among or in association with one or more processing or storage devices. A “storage device” or “memory” can include any medium or media that can store, communicate, or transport instructions, data or other types of information. The memory can be, for example, solid state, magnetic, optical, etc.

A “processor” or “process” can include any hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. In different embodiments, portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated either explicitly or from context. Combinations of components or steps will also be considered as being noted, where terminology is foreseen as rendering the ability to separate or combine is unclear.

As used in the description herein and throughout the claims that follow, “a,” “an,” and “the” include plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what may be described in the Title or Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for identifying candidate persons of an enterprise team, the method comprising the following acts performed by one or more hardware processors:
accepting a signal from a user input device to select a first user option including one or more persons based on a first set of one or more criteria
mapping, in response to the signal, information to a two dimensional graph having two transversely extending axes one of which is scaled to represent proficiency in a first metric and a second of the two transversely extending axes scaled to represent proficiency in a second metric, defining a personnel plot;
rendering the personnel plot on a display in data communication with the one or more hardware processors;
providing a second user option to choose one or more candidate persons for an enterprise team based on the information; and
bestowing a third user option to generate a range of values and display spatial data of the information with respect to the transversely extending axes over the range of values.

2. The method of claim 1 wherein bestowing further includes generating a range of time values.

3. (canceled)

4. The method of claim 3, wherein the first metric includes a measurement of versatility of a person.

5. The method of claim 3, wherein the second metric includes a measurement of sales performance, and wherein the enterprise team includes a sales team.

6. The method of claim 2, further including providing a fourth user option to selectively overlay data on a graphical depiction.

7. The method of claim 6, further including selectively overlaying data on the visualization by providing a color-coded legend and coloring the indications according to the legend and data selected to be overlaid.

8. The method of claim 7, wherein overlaid data includes industry information associated with each indication.

9. The method of claim 7, wherein overlaid data includes names associated with each indication.

10. The method of claim 7, wherein overlaid data includes a mobility metric associated with each indication.

11. The method of claim 6, further including providing a fifth user option to assign a task or goal to one or more persons associated with a displayed indication.

12. The method of claim 6, further including providing a sixth user option to add a note associated with one or more persons corresponding to a displayed indication of the one or more persons.

13. The method of claim 1, wherein retrieving data includes obtaining data from an Incentive Compensation (IC) system.

14. The method of claim 1, wherein retrieving data includes obtaining data from a Customer Relationship Management (CRM) system.

15. The method of claim 1, wherein retrieving data further includes retrieving data from a Human Capital Management (HCM) system.

16. (canceled)

17. The method of claim 1, wherein the first set of one or more criteria includes a measurement of product knowledge associated with the person.

18. The method of claim 1, wherein providing a second user option further includes providing a user interface control for assigning, to a group space, one or more chosen candidate persons selected or to be selected for a sales team.

19. An apparatus comprising:
a digital processor coupled to a display and to a processor-readable storage device, wherein the processor-readable storage device includes one or more instructions executable by the digital processor to perform the following acts:
providing a first user option to select one or more persons based on a first set of one or more criteria, yielding an indication of one or more candidate persons in response thereto;
mapping, in response to the signal, information to a two dimensional graph having two transversely extending axes one of which is scaled to represent proficiency in a first metric and a second of the two transversely extending axes scaled to represent proficiency in a second metric, defining a personnel plot;
rendering the personnel plot on a display in data communication with the one or more hardware processors;
providing a second user option to choose one or more candidate persons for an enterprise team based on the information; and
bestowing a third user option to generate a range of values and display spatial data of the information with respect to the transversely extending axes over the range of values.

20. A processor-readable storage device including instructions executable by a digital processor, the processor-readable storage device including one or more instructions for:
providing a first user option to select one or more persons based on a first set of one or more criteria, yielding an indication of one or more candidate persons in response thereto;
mapping, in response to the signal, information to a two dimensional graph having two transversely extending axes one of which is scaled to represent proficiency in a first metric and a second of the two transversely extending axes scaled to represent proficiency in a second metric, defining a personnel plot;
rendering the personnel plot on a display in data communication with the one or more hardware processors;
providing a second user option to choose one or more candidate persons for an enterprise team based on the information; and
bestowing a third user option to generate a range of values and display spatial data of the information with respect to the transversely extending axes over the range of values.

21. The apparatus of claim 19 wherein the act of bestowing further includes generating a range of time values.

22. The processor-readable storage device of claim 20 wherein the one or more instructions for bestowing further includes a subroutine for generating a range of time values.
